(19) United States
(12) Patent Application Publication
(10) Pub. No.: US 2008/0057862 A1
(43) Pub. Date: Mar. 6, 2008

(54) ULTRA WIDE BAND STAND-ALONE REPEATER/SELECTOR AND SYSTEMS

(76) Inventor: James P. Smith, Mesa, AZ (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/469,356

(22) Filed: Aug. 31, 2006

(51) Int. Cl. H04B 7/15

(52) U.S. Cl. 455/11.1

(57) ABSTRACT

Embodiments of the present invention provide an ultra wide band stand-alone repeater/selector, and apparatuses incorporating the repeater/selector. Other embodiments may be described and claimed.

### TECHNICAL FIELD

Embodiments of the present invention relate to the field of wireless networks, and more particularly, to an ultra wide band stand-alone repeater/selector, and apparatuses incorporating the repeater/selector.

### BACKGROUND

With many mobile stations used in wireless networks, an antenna is located at a lid of the mobile station, while one or more radios are located at the motherboard disposed in a base body of the mobile station. Generally, a radio disposed on the motherboard is operatively coupled to the antenna disposed at the lid via a cable. Thus, there may be signal loss as the signal travels from the antenna to the radio.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 is a schematic diagram representation of an example wireless communication system, in accordance with various embodiments of the present invention;

FIG. 2 is a block diagram representation of an example platform with multiple radios, in accordance with various embodiments of the present invention;

FIG. 3 is a schematic diagram of a stand alone repeater/selector, in accordance with various embodiments of the present invention;

FIG. 4 is a schematic representation of ultra wide band radio channel groups; and

FIG. 5 illustrates a mobile station, in with various embodiments of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B)”. For the purposes of the present invention, the phrase “at least one of A, B, and C” means “(A), (B), (C), (A and B), (A and C), (B and C), or (A, B and C)”. For the purposes of the present invention, the phrase “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present invention provide an ultra wide band stand-alone repeater/selector, and systems incorporating the repeater/selector.

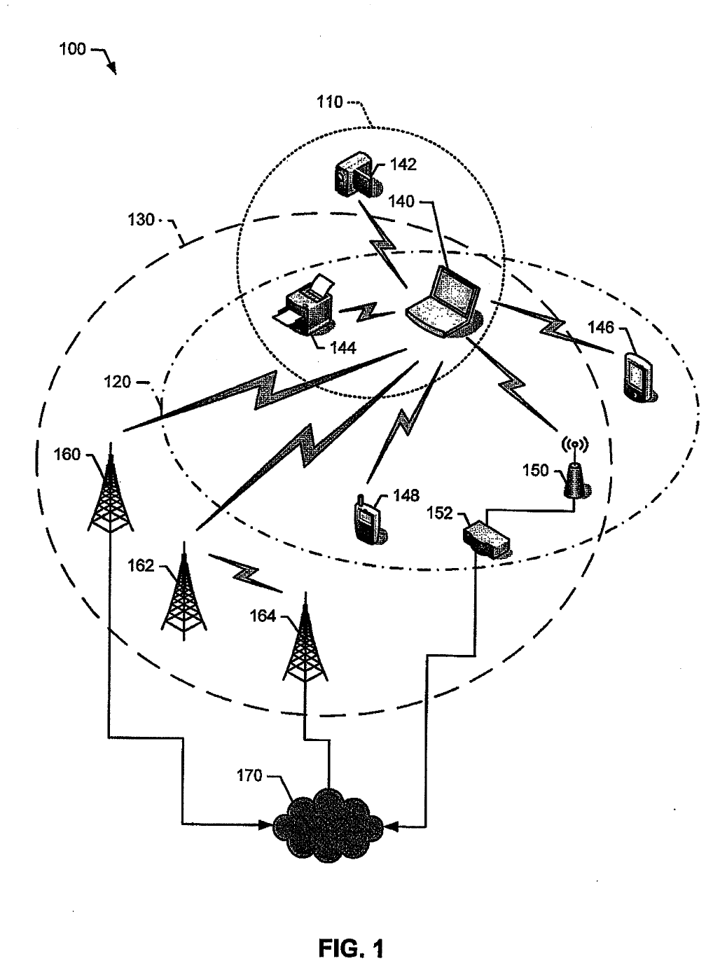

Referring to FIG. 1, an example wireless communication system 100 may include one or more wireless communication networks, generally shown as 110, 120, and 130, within which embodiments of the present invention may be practiced. In particular, the wireless communication system 100 may include a wireless personal area network (WPAN) 110, a wireless local area network (WLAN) 120, and a wireless metropolitan area network (WMAN) 130. Although FIG. 1 depicts three wireless communication networks, the wireless communication system 100 may include additional or fewer wireless communication networks. For example, the wireless communication system 100 may include additional WPANs, WLANs, and/or WMANs. The methods and apparatus described herein are not limited in this regard.

The wireless communication system 100 may also include one or more subscriber stations, generally shown as 140, 142, 144, 146, and 148. At least one of subscriber stations 140, 142, 144, 146 and 148 advantageously incorporate an embodiment of the repeater/selector of the present invention. For example, the subscriber stations 140, 142, 144, 146, and 148 may include wireless electronic devices such as a desktop computer, a laptop computer, a handheld computer, a tablet computer, a cellular telephone, a pager, an audio and/or video player (e.g., an MP3 player or a DVD player), a gaming device, a video camera, a digital camera, a navigation device (e.g., a GPS device), a wireless peripheral (e.g., a printer, a scanner, a headset, a keyboard, a mouse, etc.), a medical device (e.g., a heart rate monitor, a blood pressure monitor, etc.), and/or other suitable fixed, portable, or mobile electronic devices, at least one of which incorporates the repeater/selector to be described more fully below. Although FIG. 1 depicts five subscriber stations, the wireless communication system 100 may include more or less subscriber stations.

Each of the subscriber stations 140, 142, 144, 146, and 148 may be authorized or allowed to access services provided by one or more of the wireless communication networks 110, 120, and/or 130. The subscriber stations 140, 142, 144, 146, and 148 may use a variety of modulation techniques such as spread spectrum modulation (e.g., direct sequence code division multiple access (DS-CDMA) and/or frequency hopping code division multiple access (FH-CDMA)), time-division multiplexing (TDM) modulation, frequency-division multiplexing (FDM) modulation, orthogonal frequency-division multiplexing (OFDM) modulation (e.g., orthogonal frequency-division multiple access (OFDMA)), multi-carrier modulation (MDM), and/or other suitable modulation techniques to communicate via wireless links. In one example, the laptop computer 140 may operate in accordance with suitable wireless communication protocols that require very low power such as Bluetooth®, ultra-wide band (UWB), and/or radio frequency identification (RFID) to implement the WPAN 110. In particular, the laptop computer 140 may communicate with devices associated with the WPAN 110 such as the video camera 142 and/or the printer 144 via wireless links.

In another example, the laptop computer 140 may use direct sequence spread spectrum (DSSS) modulation and/or frequency hopping spread spectrum (FHSS) modulation to implement the WLAN 120 (e.g., the 802.11 family of standards developed by the Institute of Electrical and Electronic Engineers (IEEE) and/or variations and evolutions of these standards). For example, the laptop computer 140 may communicate with devices associated with the WLAN 120 such as the printer 144, the handheld computer 146 and/or the smart phone 148 via wireless links. The laptop computer 140 may also communicate with an access point (AP) 150 via a wireless link. The AP 150 may be operatively coupled to a router 152 as described in further detail below. Alternatively, the AP 150 and the router 152 may be integrated into a single device (e.g., a wireless router).

The laptop computer 140 may use OFDM modulation to transmit large amounts of digital data by splitting a radio frequency signal into multiple small sub-signals, which in turn, are transmitted simultaneously at different frequencies. In particular, the laptop computer 140 may use OFDM modulation to implement the WMAN 130. For example, the laptop computer 140 may operate in accordance with the 802.16 family of standards developed by IEEE to provide for fixed, portable, and/or mobile broadband wireless access (BWA) networks (e.g., the IEEE std. 802.16-2004 (published Sep. 18, 2004), the IEEE std. 802.16e (published Feb. 28, 2006), the IEEE std. 802.16f (published Dec. 1, 2005), etc.) to communicate with base stations, generally shown as 160, 162, and 164, via wireless link(s).

Although some of the above examples are described above with respect to standards developed by IEEE, the methods and apparatus disclosed herein are readily applicable to many specifications and/or standards developed by other special interest groups and/or standard development organizations (e.g., Wireless Fidelity (Wi-Fi) Alliance, Worldwide Interoperability for Microwave Access (WiMAX) Forum, Infrared Data Association (IrDA), Third Generation Partnership Project (3GPP), etc.). The methods and apparatus described herein are not limited in this regard.

The WLAN 120 and WMAN 130 may be operatively coupled to a common public or private network 170 such as the Internet, a telephone network (e.g., public switched telephone network (PSTN)), a local area network (LAN), a cable network, and/or another wireless network via connection to an Ethernet, a digital subscriber line (DSL), a telephone line, a coaxial cable, and/or any wireless connection, etc. In one example, the WLAN 120 may be operatively coupled to the common public or private network 170 via the AP 150 and/or the router 152. In another example, the WMAN 130 may be operatively coupled to the common public or private network 170 via the base station(s) 160, 162, and/or 164.

The wireless communication system 100 may include other suitable wireless communication networks. For example, the wireless communication system 100 may include a wireless wide area network (WWAN) (not shown). The laptop computer 140 may operate in accordance with other wireless communication protocols to support a WWAN. In particular, these wireless communication protocols may be based on analog, digital, and/or dual-mode communication system technologies such as Global System for Mobile Communications (GSM) technology, Wideband Code Division Multiple Access (WCDMA) technology, General Packet Radio Services (GPRS) technology, Enhanced Data GSM Environment (EDGE) technology, Universal Mobile Telecommunications System (UMTS) technology, 3GPP technology, standards based on these technologies, variations and evolutions of these standards, and/or other suitable wireless communication standards. Although FIG. 1 depicts a WPAN, a WLAN, and a WMAN, the wireless communication system 100 may include other combinations of WPANs, WLANs, WMANs, and/or WWANs. The methods and apparatus described herein are not limited in this regard.

The wireless communication system 100 may include other WPAN, WLAN, WMAN, and/or WWAN devices (not shown) such as network interface devices and peripherals (e.g., network interface cards (NICs)), access points (APs), redistribution points, end points, gateways, bridges, hubs, etc. to implement a cellular telephone system, a satellite system, a personal communication system (PCS), a two-way radio system, a one-way pager system, a two-way pager system, a personal computer (PC) system, a personal data assistant (PDA) system, a personal computing accessory (PCA) system, and/or any other suitable communication system. Although certain examples have been described above, the scope of coverage of this disclosure is not limited thereto.

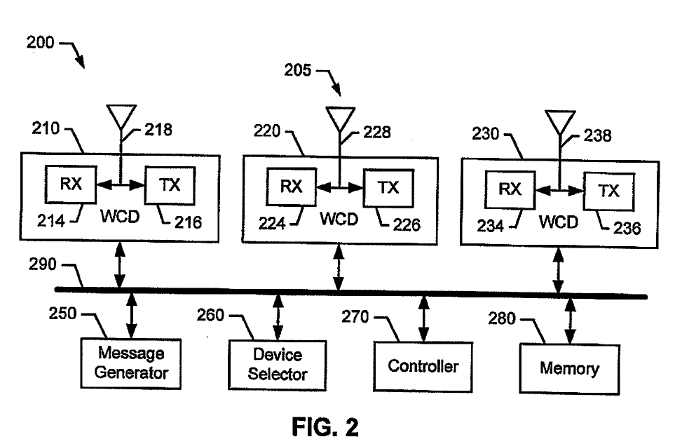

In the example of FIG. 2, a platform 200 may include a plurality of wireless communication devices or radios 205, generally shown as 210, 220, and 230. The platform 200 may be a part of and/or integrated into one of the wireless electronic devices mentioned above in connection with FIG. 1 or any combination thereof. For example, the platform 200 may also include a message generator 250, a device selector 260, a controller 270, and a memory 280. The plurality of radios 205, the device selector 250, the message generator 260, the controller 270, and the memory 280 may be operatively coupled to each other via a bus 290. While FIG. 2 depicts components of the platform 200 coupling to each other via the bus 290, these components may be operatively coupled to each other via other suitable direct or indirect connections (e.g., a point-to-point connection or a point-to-multiple point connection). Further, although FIG. 2 depicts three radios, the platform 200 may include more or less radios.

Each of the plurality of radios 205 may include a receiver (RX), generally shown as 214, 224, and 234, and a transmitter (TX), generally shown as 216, 226, and 236. Accordingly, each of the plurality of radios 205 may receive and/or transmit data via the receivers 214, 224, and 234 and the transmitters 216, 226, and 236, respectively. Each of the plurality of radios 205 may also include an antenna, generally shown as 218, 228, and 238. Each of the antennas 218, 228, and 238 may include one or more directional or omni-directional antennas such as dipole antennas, monopole antennas, patch antennas, loop antennas, microstrip antennas, and/or other types of antennas suitable for transmission of radio frequency (RF) signals. Although FIG. 2 depicts a single antenna associated with each of the plurality of radios 205, each of the plurality of radios 205 may include additional antennas. For example, each of the plurality of radios 205 may include a plurality of antennas to implement a multiple-input-multiple-output (MIMO) system.

Each of the plurality of radios 205 may be associated with a wireless communication network such as, for example, a WPAN, a WLAN, a WMAN, a WWAN, or a wireless mesh network. As noted above in connection with FIG. 1, each type of wireless communication network may operate based on a particular wireless communication technology. To illustrate the application of the plurality of radios 205 with heterogeneous wireless communication networks, the radio 210 may operate based on Wi-Fi technology, the radio 220 may operate based on WiMAX technology, and the radio 230 may operate based on Third Generation (3G) technology. Each of the plurality of radios 205 may be used to perform various applications based on a variety of factors such as quality of service (QoS), cost per bit, coverage area, mobility, etc. In one example, the radio 210 may be used for transmission control protocol (TCP) and/or web browsing, the radio 220 may be used for video streaming, and the radio 230 may be used for voice over Internet protocol (VoIP). Although the plurality of radios 205 is described above to operate in a particular manner, the plurality of radios 205 may be used to perform various applications.

Briefly, Wi-Fi technology may provide high-speed wireless connectivity within a range of a wireless access point (e.g., a hotspot) in different locations including homes, offices, cafes, hotels, airports, etc. In particular, Wi-Fi technology may allow a wireless device to connect to a local area network without physically plugging the wireless device into the network when the wireless device is within a range of a wireless access point (e.g., within 150 feet indoor or 300 feet outdoors). In one example, Wi-Fi technology may offer high-speed Internet access and/or Voice over Internet Protocol (VoIP) service connection to wireless devices. The 802.11 family of standards was developed by IEEE to provide for WLANs (e.g., the IEEE std. 802.11a published 1999, the IEEE std. 802.11b published 1999, the IEEE std. 802.11g published 2003, variations, and/or evolutions of these standards). The Wi-Fi Alliance facilitates the deployment of WLANs based on the 802.11 standards. In particular, the Wi-Fi Alliance ensures the compatibility and inter-operability of WLAN equipment. For convenience, the terms “802.11” and “Wi-Fi” may be used interchangeably throughout this disclosure to refer to the IEEE 802.11 suite of air interface standards.

WiMAX technology may provide last-mile broadband connectivity in a larger geographical area (e.g., hot zones than other wireless technology such as Wi-Fi technology. In particular, WiMAX technology may provide broadband or high-speed data connection to various geographical locations where wired transmission may be too costly, inconvenient, and/or unavailable. In one example, WiMAX technology may offer greater range and bandwidth to enable T1-type service to businesses and/or cable/digital subscriber line (DSL)-equivalent access to homes. The 802.16 family of standards was developed by IEEE to provide for fixed, portable, and/or mobile broadband wireless access networks (e.g., the IEEE std. 802.16-2004 published 2004, the IEEE std. 802.16e published 2006, the IEEE std. 802.16f published 2005, variations, and/or evolutions of these standards). The WiMAX Forum facilitates the deployment of broadband wireless access networks based on the IEEE 802.16 standards. In particular, the WiMAX Forum ensures the compatibility and inter-operability of broadband wireless equipment. For convenience, the terms “802.16” and “WiMAX” may be used interchangeably throughout this disclosure to refer to the IEEE 802.16 suite of air interface standards.

Third Generation technology may provide broad-range coverage for voice communications, data access, and/or Internet connectivity across wide geographic areas. In particular, 3G technology may provide great mobility for devices whose primary function is voice services with additional data applications as a complement to those services. For example, such devices may include cellular telephones that may also provide interactive video conferencing, or a handheld computers (or PDAs) that may provide full-playback DVD services. To provide such high-speed wireless communication services, the International Mobile Telecommunications (IMT-2000) family of standards was developed by the International Telecommunications Unit (e.g., W-CDMA, CDMA2000, etc.).

Although the components shown in FIG. 2 are depicted as separate blocks within the platform 200, the functions performed by some of these blocks may be integrated within a single semiconductor circuit or may be implemented using two or more separate integrated circuits. In one example, although the receiver 214 and the transmitter 216 are depicted as separate blocks within the radio 210, the receiver 214 may be integrated into the transmitter 216 (e.g., a transceiver). In another example, the message generator 250, device selector 260, and/or the controller 270 may integrated into a single component (e.g., a processor). The methods and apparatus described herein are not limited in this regard.

Although the above examples are described with respect to particular wireless communication technologies, the plurality of radios 205 may operate based on other suitable types of wireless communication technology. For example, one or more of the plurality of radios 205 may operate based on UWB.

In accordance with various embodiments of the present invention, the components for a radio, as described above, may be made up of one or more modules. At least one of the modules, in accordance with various embodiments of the present invention, may include a repeater/selector arrangement. In accordance with various embodiments of the present invention, the repeater/selector arrangement may also be referred to as an up/down converter.

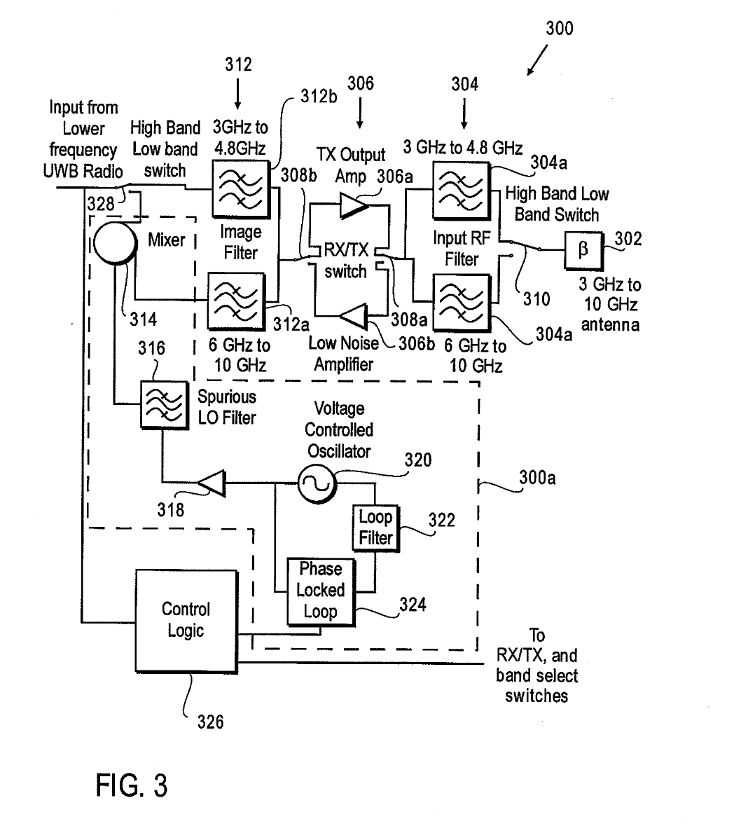

In an embodiment of the present invention, the radio may be configured as an ultra wide band radio (UWB). At least a module of the radio that includes a repeater/selector arrangement, in accordance with such an embodiment of the present invention, is configured to be located within the lid of a mobile station. With reference to FIG. 3, an example of a receiver/selector arrangement 300 for use with a UWB radio, in accordance with various embodiments of the present invention, may be described. In this example, an antenna 302 may be included with the repeater/selector arrangement, although the antenna may not be included in other examples and thus, may be separate. The antenna may be operatively coupled to an input radio frequency (RF) filter 304. The input filter may be configured with one or more filters 304a, 304b to allow for either high band or low band transmissions and receptions. An amplifier arrangement 306 may be included that, in accordance with various embodiments of the present invention, includes a transmission output amplifier 306a and a low noise amplifier 306b. Reception/transmission switches 308a, 308b may be provided to allow for use of the transmission output amp during transmission by a radio that includes the repeater/selector arrangement and for use of the low noise amplifier during reception by the radio. A high band/low band switch 310 may be provided between the RF filter and antenna to select which filter to direct or receive signals to or from based upon a mode of operation of the radio. An image filter 312 may also be provided that includes a high band image filter 312a and a low band image filter 312b and is operatively coupled to the amplifier arrangement.

A portion 300a of arrangement 300 may be provided to up convert and down convert signals, in accordance with various embodiments of the present invention. In accordance with such an embodiment, a mixer 314 may be operatively coupled to the high band image filter and may also be operatively coupled to further processing components in the form of a spurious local oscillator (LO) filter 316, an RF amplifier 318, a voltage controlled oscillator 320, a loop filter 322 and a phase-locked loop 324. The phase-locked loop may be operatively coupled to control logic 326, which may be operatively coupled to a receiver and a transmitter of the radio, as well as band select switches (not shown). A high band/low band switch 328 may be provided to direct or receive signals to or from the mixer, or to bypass the mixer, based upon a mode of operation of the radio.

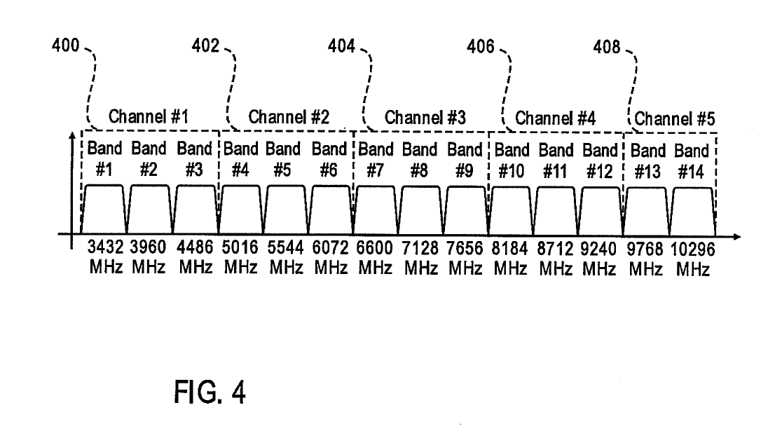

In accordance with various embodiments of the present invention, and with reference to FIG. 4, portion 300a of the repeater/selector arrangement may be configured to up/down convert the three lower UWB channels band of group one (400), more particularly, the channels in the 3.168 to 4.752 GHz range to the upper UWB channels band of groups three, four, five (402, 404, 406, respectively), specifically, 6.336 to 10.560 GHz in both receiver and transmitter modes of operation. In accordance with various embodiments of the present invention, in a receiver mode, portion 300a of the arrangement may down convert band group three, four, five signals to band group one channels, while in a transmitter mode, the portion 300a of the arrangement may up convert the band group one signals to band group three, four, five channels, depending upon the desired transmission and receiving frequencies.

The repeater/selector arrangement also may operate in a repeater mode, in accordance with various embodiments of the present invention, wherein it takes 3.168 to 4.752 GHz transmission signals and amplifies the signals prior to transmission. Switch 328 of FIG. 3 may be used to enable this mode. The repeater/selector arrangement also may amplify a received signal, thereby improving the signal to noise ratio.

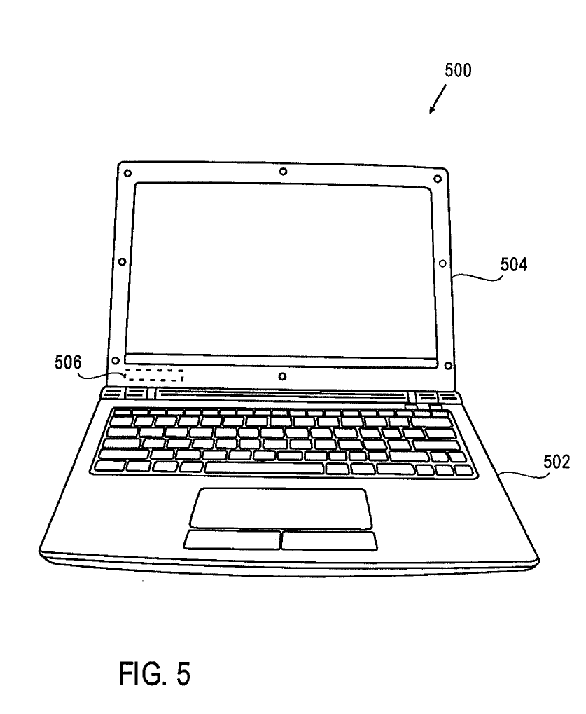

FIG. 5 illustrates a mobile station 500 in accordance with various embodiments of the present invention. The mobile station 500, in this example, is a laptop or notebook computer that comprises a body 502 and a lid 504. A module 506, in accordance with various embodiments of the present invention, may include, for example, a repeater/selector arrangement as previously described and is located within lid 504.

In accordance with various embodiments of the present invention, the module that includes the repeater/selector arrangement may be controlled, configured and powered by the same cable that is used to transmit the radio frequency signal to the repeater/selector module from one or more radio modules within body 502 of mobile device 500 to the repeater/selector module within lid 504. Communication, in accordance with various embodiments of the present invention, may be achieved by a half duplex serial protocol that allows the UWB MAC to control selection between the transmitter and receiver antenna selections, band selection and other configurable settings. In accordance with various embodiments of the present invention, power may be supplied by applying a DC offset of 3.3 volts that is filtered out before the RF input of the repeater/selector and a control protocol operates at a frequency high enough such that the average DC value may be, for example, approximately 3.0 volts.

The present invention minimizes the traditional cable loss that exists between a mother board radio card, traditionally mounted in the body of a mobile station, and the antenna, traditionally mounted in the platform lid of the mobile station. Additionally, by including the low noise amplifier in the lid closer to the antenna, the signal to noise ratio is improved for the signal received by the radio.

While the present invention has been described with respect to a UWB radio, those skilled in the art will understand that the present invention may be used with numerous other types of radios. Additionally, those skilled in the art will understand that one or more entire radios, made up of one or more modules, may be located within the lid of the mobile station, as opposed to one or more modules that form a portion of one or more radios being located within the lid. The one or more modules may or may not include a repeater/selector arrangement as previously described depending upon the type or types of radio(s) included with the mobile station.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. An apparatus comprising:
at least one radio comprising at least one module configured to reside within a lid of a mobile station hosting the apparatus.

2. The apparatus of claim 1, wherein the at least one module comprises a repeater/selector arrangement.

3. The apparatus of claim 2, wherein the at least one radio comprises a plurality of modules and one of the modules comprises the repeater/selector arrangement and is configured to reside within the lid.

4. The apparatus of claim 1, wherein the at least one radio comprises a single module that is configured to reside within the lid.

5. The apparatus of claim 2, wherein the at least one radio is configured as an ultra wide band radio.

6. The apparatus of claim 2, wherein the mobile station comprises an antenna located within the lid and the repeater/selector arrangement comprises an amplifier operatively coupled to the antenna.

7. The apparatus of claim 6, wherein the repeater/selector arrangement comprises the antenna.

8. The apparatus of claim 7, wherein the repeater/selector arrangement further comprises a mixer operatively coupled to the amplifier, the amplifier being located between the antenna and the mixer.

9. The apparatus of claim 8, wherein the amplifier comprises an output amplifier and a low noise amplifier operatively coupled to one another in parallel by a receiver/transmitter switch.

10. The apparatus of claim 7, wherein the antenna is configured to cover a range of 3 gigahertz to 10.3 gigahertz.

11. A method comprising:
receiving a signal by a radio comprising at least one module comprising an amplifier and the at least one module being located within a lid of a mobile station;
amplifying the signal with the amplifier; and
handling the signal by a further portion of the radio.

12. The method of claim 11, wherein the at least one module further comprises a repeater/selector arrangement, and the method further comprises processing the signal with the repeater/selector arrangement to convert the signal to a different frequency.

13. The method of claim 11, wherein the amplifier comprises a low noise amplifier, and the amplifying the signal comprises amplifying the signal with a low noise amplifier.

14. The method of claim 11, wherein the module further comprises a filter, and the method further comprises filtering the signal by the filter prior to amplifying the signal.

15. The method of claim 11, wherein handling the signal comprises providing the signal to a further portion of the radio located within the lid.

16. The method of claim 11, wherein handling the signal comprises providing the signal to a further portion of the radio that is not located within the lid.

17. A method comprising:
processing a signal by a radio comprising at least one module comprising a repeater/selector arrangement and the at least one module being located within a lid of a mobile station;
further processing the signal with the repeater/selector arrangement;
amplifying the signal with an amplifier of the repeater/selector arrangement; and
transmitting the signal.

18. The method of claim 17, wherein further processing the signal comprises converting the signal to a different frequency.

19. A mobile system comprising:
a lid;
an omnidirectional antenna disposed in the lid;
at least one radio comprising at least one module, the at least one module comprising a repeater/selector arrangement operatively coupled to the antenna and being co-located with the antenna within the lid.

20. The mobile system of claim 19, wherein the at least one radio comprises a plurality of modules and one of the modules comprises the repeater/selector arrangement and is located within the lid.

21. The mobile system of claim 20, wherein the at least one radio comprises a single module and is located within the lid.

22. The mobile system of claim 20, wherein the mobile station the repeater/selector arrangement comprises an amplifier operatively coupled to the antenna.

23. The mobile system of claim 22, wherein the repeater/selector arrangement comprises the antenna.
